(19) United States
(12) Patent Application Publication
(10) Pub. No.: US 2013/0193904 A1
(43) Pub. Date: Aug. 1, 2013

(54) Charging unit useful to transform a high plurality of Energy Storage Devices

(71) Applicant: earthCell, Inc., Oakland, CA (US)

(72) Inventor: Jason Rugolo, Scottsdale, AZ (US)

(73) Assignee: earthCell, Inc., Oakland, CA (US)

(21) Appl. No.: 13/573,757

(22) Filed: Oct. 3, 2012

Related U.S. Application Data
(60) Provisional application No. 61/542,709, filed on Oct. 3, 2011.

(51) Int. Cl. H02J 7/00

(52) U.S. Cl. CPC H02J 7/0042
USPC 320/101; 320/107

(57) ABSTRACT

Disclosed herein are system for managing transformation of large numbers of energy storage devices. Also provided are computer-implemented methods for managing the transformation of a large number of energy storage devices. Also provided are charging units to transform high plurality of energy storage devices to substantially charged state.

### CROSS-REFERENCE TO RELATED APPLICATION

The present application is a non-provisional application which claims priority to U.S. Provisional Patent Application No. 61/542,709, filed Oct. 3, 2011; all of which is herein incorporated by reference in its entirety.

### FIELD OF INVENTION

This invention relates to systems and methods for managing distribution, and transformation of energy storage devices. Charging units to transform energy storage devices from substantially uncharged to substantially charged state are provided herein.

### BACKGROUND OF THE INVENTION

Energy storage devices such as electrochemical cells store energy well and for a considerable length of time. Primary electrochemical cells are non-rechargeable, hence need to be discarded when the stored energy is depleted, and the cell is transformed from a charged state to an uncharged state.

### SUMMARY OF THE INVENTION

Disclosed herein are methods and system for managing transformation of energy storage devices. Also provided are computer-implemented methods for managing transformation and distribution of energy storage devices. Also provided are charging units to transform energy storage devices to substantially charged state.

Provided herein are systems for managing transformation of energy storage devices. In certain embodiments is a system for transformation of energy storage devices, wherein said system comprises at least one charging unit useful to transform a plurality of energy storage devices to a substantially charged state; at least one processing unit; and at least one sequence of program instructions stored in an electronic digital memory in said processing unit, which when executed cause at least one step selected from transformation, inventory, and storage of energy storage devices. In some embodiments, the processing unit is a computer.

Provided are systems for managing transformation of energy storage devices, wherein transformation of the energy storage devices is performed by providing by means of a charging unit, electricity in an amount sufficient to transform said energy storage devices to a substantially charged state. In certain embodiments, the charging unit provides electricity sufficient to transform the energy storage device from a substantially uncharged state to a substantially charged state.

Certain embodiments of the systems described herein comprise at least one charging unit for transforming energy storage devices to a substantially charged state, wherein said charging unit can simultaneously charge a plurality of energy storage devices by transforming said devices from a substantially uncharged state to a substantially charged state. In certain embodiments, provided are charging units that maintain substantially charged energy storage devices in said substantially charged state. In an embodiment is a charging unit that can simultaneously charge at least 20 energy storage devices. In certain embodiments are charging units that can simultaneously charge at least 50 energy storage devices. In an embodiment provided is a charging unit that can simultaneously charge at least 100 energy storage devices. In some embodiments are charging units that can simultaneously charge at least 1000 energy storage devices. In some embodiments, are charging units that can simultaneously charge at least 10000 energy storage devices. In certain embodiments are charging units that can charge at least 100000 energy storage devices. In certain embodiments, a plurality of charging units are simultaneously provided in a system described herein. In a further embodiment, at least 5 charging units are simultaneously provided in a system described herein. In certain embodiments, 10 charging units are deployed simultaneously to charge a high plurality of energy storage devices. In an embodiment, 50 charging units are provided. In a further embodiment, at least 100 charging units are provided. In some embodiments, at least 1000 charging units that can simultaneously charge between 10 and 100000 energy storage devices are provided in systems described herein.

Provided are systems for managing transformation of energy storage devices, wherein transformation of the energy storage devices is performed by providing electricity in an amount sufficient to transform said energy storage devices to a substantially charged state, and wherein the system regulates the supply of electricity to the energy storage devices. In an embodiment, the regulation further comprises prevention of overcharging charged energy storage devices. In some embodiments, the system regulates the supply of energy by performing hysteresis charging prior to constant voltage charging. In certain embodiments, the system regulates the supply of electricity so as to minimize charging during peak hours.

Provided are systems for managing transformation of energy storage devices, wherein transformation of the energy storage devices is performed by providing electricity in an amount sufficient to transform said energy storage devices from a substantially uncharged state to a substantially charged state, and wherein at least some of the electricity is obtained from a renewable source. In certain embodiments, the renewable source of electricity is solar. In certain embodiments, the renewable source of electricity is biomass, bio-fuel, geothermal, tidal, hydroelectric, wind, solar or combinations thereof.

Provided are systems for managing distribution and transformation of energy storage devices, wherein said energy storage devices are electrochemical cells. In certain embodiments, the electrochemical cell is a rechargeable electrochemical cell. In some embodiments, the electrochemical cell is a secondary electrochemical cell. In certain embodiments, the electrochemical cells have a power-to-weight ratio of about 50 to about 25000 W/kg. In certain embodiments, the electrochemical cells transformed and distributed by the systems described herein, are not automobile traction batteries. In some embodiments, the electrochemical cells transformed and distributed by the systems described herein, are not electric vehicle batteries.

In some embodiments, the electrochemical cells useful in the systems, and methods described herein are low self-discharge cells. In certain embodiments, the rechargeable electrochemical cells are alkaline cells. In certain embodiments, the rechargeable electrochemical cells are one or more of nickel-metal hydride cells, nickel-iron cells, nickel-cadmium cells, nickel-hydrogen cells, nickel-zinc cells, lithium ion cells, lithium polymer cells, lithium-iron-phosphate cells, lithium-sulfur cells, lithium-titanate cells, thin film lithium cells, zinc bromide cells, silver oxide cells, silver-zinc cells; vanadium redox cells, sodium-sulfur cells, molten salt cells and combinations thereof. In some embodiments, the rechargeable electrochemical cells are molten salt cells such as sodium-sulfur cells, lithium-sulfur cells, sodium-aluminum chloride cells or combinations thereof.

Provided herein is a system for managing transformation of energy storage devices, wherein said system comprises at least one charging unit that comprises: at least one positive component; at least one negative component; and receptacles to contain a plurality of energy storage devices. In certain embodiments, the energy storage devices are electrochemical cells. In certain embodiments is provided a system as described herein, wherein the charging unit is an electrochemical cell testing equipment. In certain embodiments, the charging unit is an electrochemical cell formation and grading machine. In certain embodiments, at least one transforming unit is contained within a distribution unit useful to receive and dispense energy storage devices. In certain embodiments, the transforming unit is separate from a distribution unit useful to receive and dispense energy storage devices, and said energy storage devices are transported from the distribution unit to the transformation unit by means of a delivery service. In some embodiments, the delivery service is a courier service.

Provided herein are methods of managing transformation of energy storage devices. In an embodiment is a computer-implemented method of managing transformation of energy storage devices, wherein said method comprises: transforming energy storage devices to a substantially charged state; utilizing at least one sequence of computer program instructions stored in an electronic digital memory in a computer to manage at least one step selected from organization, transformation, inventory, and storage of energy storage devices.

In an embodiment is a method wherein transformation of the energy storage devices is performed by providing electricity in an amount sufficient to transform said energy storage devices from a substantially uncharged state to a substantially charged state. In certain embodiments, the method further comprises maintaining substantially charged energy storage devices in said substantially charged state. In certain embodiments the method further comprises regulating the supply of electricity to the energy storage devices. In some embodiments, the regulation further comprises prevention of overcharging charged energy storage devices.

Provided herein is a charging unit for transforming energy storage devices to a substantially charged state, said unit comprising: at least one positive component; at least one negative component; and receptacles to contain a plurality of energy storage devices, wherein said charging unit provides energy in an amount sufficient to transform said energy storage devices to a substantially charged state. In certain embodiments, the receptacles align the plurality of energy storage devices in a series arrangement between said at least one positive component and said at least one negative component. In some embodiments, the receptacles align the plurality of energy storage devices in a parallel arrangement between said at least one positive component and said at least one negative component. In a further embodiment, the receptacles comprise a locking mechanism to hold the energy storage devices in place. In some embodiments, the locking mechanism is a clip. In an embodiment, the locking mechanism is a cartridge. In certain embodiments, the locking mechanism is a spring pin. In an embodiment, the locking mechanism is a clamp. In certain embodiments, the locking mechanism is a groove, or a slot. In a further embodiment, the locking mechanism is a gravitational lock. In an embodiment, the locking mechanism is not activated if energy storage devices are placed in the receptacle in an improper orientation.

Provided herein is a charging unit for transforming energy storage devices to a substantially charged state, said unit comprising: at least one positive component; at least one negative component; and receptacles to contain a plurality of energy storage devices, wherein said charging unit provides energy in an amount sufficient to transform said energy storage devices to a substantially charged state; and wherein said transformation of the energy storage devices is performed by providing electricity in an amount sufficient to transform said energy storage devices from a substantially uncharged state to a substantially charged state. In certain embodiments, the charging unit maintains substantially charged energy storage devices in said substantially charged state. In an embodiment is a charging unit that can simultaneously charge at least 20 energy storage devices. In certain embodiments are charging units that can simultaneously charge at least 50 energy storage devices. In an embodiment provided is a charging unit that can simultaneously charge at least 100 energy storage devices. In some embodiments are charging units that can simultaneously charge at least 1000 energy storage devices. In some embodiments, are charging units that can simultaneously charge at least 10000 energy storage devices. In certain embodiments are charging units that can charge at least 100000 energy storage devices.

In certain embodiments is provided a charging unit as described herein, wherein the charging unit regulates the supply of energy to the energy storage devices. In some embodiments, the regulation further comprises prevention of overcharging of charged energy storage devices. In an embodiment, at least some of the electricity needed to convert the energy storage devices to a substantially charged state is obtained from a renewable source. In certain embodiments, all of the electricity is obtained from a renewable source. In an embodiment, the renewable source of electricity is solar. In certain embodiments, the renewable source of electricity is biomass, biofuel, geothermal, tidal, hydroelectric, wind, solar or combinations thereof. In a particular embodiment, the charging unit regulates the supply of electricity so as to minimize charging during peak hours. In certain embodiments, the energy storage devices are transformed to a substantially charged state by trickle charging. In some embodiments, the energy storage devices are transformed to a substantially charged state by float charging. In an embodiment, the energy storage devices are transformed to a substantially charged state by delta-V charging. In a further embodiment, the energy storage devices are transformed to a substantially charged state by negative pulse charging. In some embodiments, the energy storage devices are transformed to a substantially charged state by inductive charging. In an embodiment, the charging unit is a smart charging unit. In some embodiments, the energy storage device is an electrochemical cell. In some embodiments, the electrochemical cell is rechargeable.

In certain embodiments are provided charging units as described herein wherein said charging units also comprise at least one control panel useful to select charging parameters. In further embodiments the control panel comprises at least one display screen. In some embodiments, the display screen is a touchscreen. In some embodiments, the selection panel comprises at least one keyboard.

In certain embodiments is provided at least one charging unit as described herein wherein said charging unit can simultaneously transform a plurality of multiple types of energy storage devices. In some embodiments, a charging unit described herein further comprises a mechanism to issue an alert. In an embodiment, the alert mechanism is triggered when at least one energy storage device cannot be transformed to a substantially charged state. In certain embodiments, the alert mechanism is triggered when all energy storage devices are transformed to a substantially charged state.

In certain embodiments is provided at least one charging unit as described herein wherein said charging unit further comprises an automated loading device that accepts energy storage devices, and dispenses said devices to an automated sorting device; and an automated sorting device. In certain embodiments, the automated loading device is a hopper. In further embodiments, the charging unit also comprises a conveyor to transport said energy storage devices from said loading device to said sorting device. In some embodiments, the sorting device aligns energy storage devices in a proper orientation for containment in the receptacle.

In certain embodiments are charging unit as described herein, wherein said charging units are designed to be contained within a distribution unit.

In certain embodiments described herein, the energy storage device is not an automobile traction battery.

Provided is a method of using a charging unit described herein for efficiently recycling energy storage devices, said method comprising: receiving at least one energy storage device in a substantially uncharged state; transforming said energy storage device from a substantially uncharged state to a substantially charged state; initiating transportation to said substantially charged energy storage device to a user. In certain embodiments, the energy storage device is an electrochemical cell. In some embodiments, the electrochemical cell is rechargeable.

Provided in certain embodiments is a system for transformation of energy storage devices, wherein said system comprises: at least one charging unit for transformation of a high plurality of energy storage devices to a substantially charged state by providing a sufficient amount of electricity; at least one processing unit optionally comprising a computer; at least one sequence of program instructions stored in an electronic digital memory in said processing unit, which when executed cause at least one step selected from transformation, inventory, and storage of energy storage devices; and optionally comprising a distribution unit to: receive energy storage devices from a sender user, dispense substantially charged energy storage devices to a recipient user, or both.

Other aspects and features of the present invention will become apparent to those ordinarily skilled in the art upon review of the following description of specific embodiments of the invention.

### BRIEF DESCRIPTION OF THE FIGURES

FIG. 1 shows a flowchart depicting a method of managing transformation of energy storage devices

FIG. 2 shows two views of an embodiment of a charging unit used to transform energy storage devices 2 to a substantially charged state.

FIG. 3 shows a partial view of an embodiment of a charging unit described herein, wherein energy storage devices are contained in a parallel arrangement.

FIG. 4 shows a partial view of an embodiment of a charging unit described herein, wherein energy storage devices are contained in a series arrangement.

FIG. 5 shows a partial view of an embodiment of a charging unit described herein, wherein energy storage devices are contained in a parallel arrangement.

FIG. 6 shows a partial view of an embodiment of a charging unit described herein, wherein said charging unit also comprises a loading device and a sorting device.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

### DETAILED DESCRIPTION OF THE INVENTION

Provided herein are systems for managing distribution and transformation of energy storage devices. Provided herein are systems for managing transformation of energy storage devices. In certain embodiments is a system for transformation of energy storage devices, wherein said system comprises at least one charging unit useful to transform a plurality of energy storage devices to a substantially charged state; at least one processing unit; and at least one sequence of program instructions stored in an electronic digital memory in said processing unit, which when executed cause at least one step selected from transformation, inventory, and storage of energy storage devices. In some embodiments, the processing unit is a computer

In general the following words and phrases have the indicated definitions when used in the description, examples and claims.

### Systems

Provided herein are systems for managing transformation of energy storage devices. In certain embodiments is a system for transformation of energy storage devices, wherein said system comprises at least one charging unit useful to transform a plurality of energy storage devices to a substantially charged state; at least one processing unit; and at least one sequence of program instructions stored in an electronic digital memory in said processing unit, which when executed cause at least one step selected from transformation, inventory, and storage of energy storage devices. In some embodiments, the processing unit is a computer.

Provided are systems for managing transformation of energy storage devices, wherein transformation of the energy storage devices is performed by providing by means of a charging unit, electricity in an amount sufficient to transform said energy storage devices to a substantially charged state. In certain embodiments, the charging unit provides electricity sufficient to transform the energy storage device from a substantially uncharged state to a substantially charged state.

Certain embodiments of the systems described herein comprise at least one charging unit for transforming energy storage devices to a substantially charged state, wherein said charging unit can simultaneously charge a plurality of energy storage devices by transforming said devices from a substantially uncharged state to a substantially charged state. In certain embodiments, provided are charging units that maintain substantially charged energy storage devices in said substantially charged state. In an embodiment is a charging unit that can simultaneously charge at least 20 energy storage devices. In certain embodiments are charging units that can simultaneously charge at least 50 energy storage devices. In an embodiment provided is a charging unit that can simultaneously charge at least 100 energy storage devices. In some embodiments are charging units that can simultaneously charge at least 1000 energy storage devices. In some embodiments, are charging units that can simultaneously charge at least 10000 energy storage devices. In certain embodiments are charging units that can charge at least 100000 energy storage devices. In certain embodiments, a plurality of charging units are simultaneously provided in a system described herein. In a further embodiment, at least 5 charging units are simultaneously provided in a system described herein. In certain embodiments, 10 charging units are deployed simultaneously to charge a high plurality of energy storage devices. In an embodiment, 50 charging units are provided. In a further embodiment, at least 100 charging units are provided. In some embodiments, at least 1000 charging units that can simultaneously charge between 10 and 100000 energy storage devices are provided in systems described herein.

Provided are systems for managing transformation of energy storage devices, wherein transformation of the energy storage devices is performed by providing electricity in an amount sufficient to transform said energy storage devices to a substantially charged state, and wherein the system regulates the supply of electricity to the energy storage devices. In an embodiment, the regulation further comprises prevention of overcharging charged energy storage devices. In some embodiments, the system regulates the supply of energy by performing hysteresis charging prior to constant voltage charging. In certain embodiments, the system regulates the supply of electricity so as to minimize charging during peak hours.

Provided are systems for managing transformation of energy storage devices, wherein transformation of the energy storage devices is performed by providing electricity in an amount sufficient to transform said energy storage devices from a substantially uncharged state to a substantially charged state, and wherein at least some of the electricity is obtained from a renewable source. In certain embodiments, the renewable source of electricity is solar. In certain embodiments, the renewable source of electricity is biomass, bio-fuel, geothermal, tidal, hydroelectric, wind, solar or combinations thereof.

Provided are systems for managing distribution and transformation of energy storage devices, wherein said energy storage devices are electrochemical cells. In, certain embodiments, the electrochemical cell is a rechargeable electrochemical cell. In some embodiments, the electrochemical cell is a secondary electrochemical cell. In certain embodiments, the electrochemical cells have a power-to-weight ratio of about 50 to about 25000 W/kg. In certain embodiments, the electrochemical cells transformed and distributed by the systems described herein, are not automobile traction batteries. In some embodiments, the electrochemical cells transformed and distributed by the systems described herein, are not electric vehicle batteries.

In some embodiments, the electrochemical cells useful in the systems, and methods described herein are low self-discharge cells. In certain embodiments, the rechargeable electrochemical cells are alkaline cells. In certain embodiments, the rechargeable electrochemical cells are one or more of nickel-metal hydride cells, nickel-iron cells, nickel-cadmium cells, nickel-hydrogen cells, nickel-zinc cells, lithium ion cells, lithium polymer cells, lithium-iron-phosphate cells, lithium-sulfur cells, lithium-titanate cells, thin film lithium cells, zinc bromide cells, silver oxide cells, silver-zinc cells, vanadium redox cells, sodium-sulfur cells, molten salt cells and combinations thereof. In some embodiments, the rechargeable electrochemical cells are molten salt cells such as sodium-sulfur cells, lithium-sulfur cells, sodium-aluminum chloride cells or combinations thereof.

Provided herein is a system for managing transformation of energy storage devices, wherein said system comprises at least one charging unit that comprises: at least one positive component; at least one negative component; and receptacles to contain a plurality of energy storage devices. In certain embodiments, the energy storage devices are electrochemical cells. In certain embodiments is provided a system as described herein, wherein the charging unit is an electrochemical cell testing equipment. In certain embodiments, the charging unit is an electrochemical cell formation and grading machine. In certain embodiments, at least one transforming unit is contained within a distribution unit useful to receive and dispense energy storage devices. In certain embodiments, the transforming unit is separate from a distribution unit useful to receive and dispense energy storage devices, and said energy storage devices are transported from the distribution unit to the transformation unit by means of a delivery service. In some embodiments, the delivery service is a courier service.

Provided herein are methods of managing transformation of energy storage devices. In an embodiment is a computer-implemented method of managing transformation of energy storage devices, wherein said method comprises: transforming energy storage devices to a substantially charged state; utilizing at least one sequence of computer program instructions stored in an electronic digital memory in a computer to manage at least one step selected from organization, transformation, inventory, and storage of energy storage devices.

In an embodiment is a method wherein transformation of the energy storage devices is performed by providing electricity in an amount sufficient to transform said energy storage devices from a substantially uncharged state to a substantially charged state. In certain embodiments, the method further comprises maintaining substantially charged energy storage devices in said substantially charged state. In certain embodiments the method further comprises regulating the supply of electricity to the energy storage devices. In some embodiments, the regulation further comprises prevention of overcharging charged energy storage devices.

### Energy Storage Device

“Energy storage device” means any device that is capable of storing or producing electrical energy. In certain embodiments, the energy storage device is an electrochemical cell that can convert stored chemical energy into electrical energy. In certain embodiments described herein, the energy storage device is not an automobile traction battery.

In some embodiments, the electrochemical cells are primary cells wherein the electrochemical reaction that converts stored chemical energy into electrical energy is irreversible. Hence, these cells once used, cannot be transformed from substantially uncharged state to substantially charged state (non-rechargeable cells). In an embodiment, the non-rechargeable cell is a non-rechargeable alkaline cell. In some embodiments, the non-rechargeable cell is a non-rechargeable zinc-carbon cell, zinc-chloride cell, Oxy-nickel cell, lithium-copper oxide cell, lithium-iron disulfide cell, lithium-manganese dioxide cell, mercury oxide cell, silver oxide cell, silver-zinc cell, zinc-air cell or combinations thereof.

In some embodiments, the electrochemical cell is a secondary cell, also referred to as a rechargeable cell or a storage cell. In these cells, the electrochemical reactions are electrically reversible. Hence, these cells can be transformed from a substantially uncharged state to a substantially charged state by means of a charging unit. In certain embodiments, the rechargeable electrochemical cells are alkaline cells. In certain embodiments, the rechargeable electrochemical cells are one or more of nickel-metal hydride cells, nickel-iron cells, nickel-cadmium cells, nickel-hydrogen cells, nickel-zinc cells, lithium ion cells, lithium polymer cells, lithium-iron-phosphate cells, lithium-sulfur cells, lithium-titanate cells, thin film lithium cells, zinc bromide cells, silver oxide cells, silver-zinc cells, vanadium redox cells, sodium-sulfur cells, molten salt cells and combinations thereof. In some embodiments, the rechargeable electrochemical cells are molten salt cells such as sodium-sulfur cells, lithium-sulfur cells, sodium-aluminum chloride cells or combinations thereof.

In certain embodiments, the electrochemical cells have a power-to-weight ratio of about 50 to about 25000 W/kg. In some embodiments, the electrochemical cells are low self-discharge cells. In certain embodiments, the electrochemical cells have specific energy of 0.05-3.0 MJ/Kg. In an embodiment, the electrochemical cells have specific energy of 0.1-0.2 MJ/Kg. In certain embodiments, the electrochemical cells have specific energy of 0.1-0.5 MJ/Kg. In certain embodiments, the electrochemical cells have specific energy of 0.5-1.5 MJ/Kg. In some embodiments, the electrochemical cells provided herein have a nominal cell voltage of 0.5-10V. In an embodiment, the electrochemical cells provided herein have a nominal cell voltage of 1.2V. In an embodiment, the electrochemical cells provided herein have a nominal cell voltage of 1.5V. In an embodiment, the electrochemical cells provided herein have a nominal cell voltage of 1.7V. In an embodiment, the electrochemical cells provided herein have a nominal cell voltage of 3.6V. In certain embodiments, the electrochemical cells are of dimensions compliant with the recommendations of the International Electrochemical Commission or American National Standards Institute. In certain embodiments, the electrochemical cell is AAA cell. In some embodiments, the electrochemical cell is a AA cell. In some embodiments, the electrochemical cells are one or more of C cell, D cell, Lantern cell, PP3 cell, 1/2AA cell, AAAA cell, A cell, B cell, F cell, N cell, No. 6 cell, Sub-C cell, A23 cell, A27 cell, 4SR44 cell, 523 cell, 531 cell, J cell, PP1 cell, PP3 cell, PP6 cell, PP7 cell, PP8 cell, PP9 cell, PP10 cell, PP11 cell, CR123A cell, CR2 cell, 2CR5 cell, CR-P2 cell, CR-V3 cell, CR11108 cell, CR3032 cell, CR2477 cell, CR2450 cell, CR2430 cell, CR2354 cell, CR2330 cell, CR2032 cell, CR2025 cell, CR927 cell, CR1025 cell.

In certain embodiments described herein, “transformation of an energy storage device” comprises transforming said device from a substantially uncharged state to a substantially charged state or from a substantially charged state to a substantially uncharged state.

In some embodiments, a substantially charged state is one wherein the energy storage device is charged to about 50% of its capacity. In an embodiment, the substantially charged state is one wherein the energy storage device is charged to about 60% of its capacity. In some embodiments, a substantially charged state is one wherein the energy storage device is charged to about 65% of its capacity. In some embodiments, a substantially charged state is one wherein the energy storage device is charged to about 70% of its capacity. In some embodiments, a substantially charged state is one wherein the energy storage device is charged to about 75% of its capacity. In some embodiments, a substantially charged state is one wherein the energy storage device is charged to about 80% of its capacity. In some embodiments, a substantially charged state is one wherein the energy storage device is charged to about 85% of its capacity. In some embodiments, a substantially charged state is one wherein the energy storage device is charged to about 90% of its capacity. In some embodiments, a substantially charged state is one wherein the energy storage device is charged to about 95% of its capacity. In some embodiments, a substantially charged state is one wherein the energy storage device is charged to about 99% of its capacity. In some embodiments, a substantially charged state is one wherein the energy storage device is charged to about 100% of its capacity.

In some embodiments, a substantially uncharged state is one wherein the energy storage device has discharged more than about 50% of its energy storage capacity. In some embodiments, a substantially uncharged state is one wherein the energy storage device has discharged more than about 55% of its energy storage capacity. In some embodiments, a substantially uncharged state is one wherein the energy storage device has discharged more than about 60% of its energy storage capacity. In some embodiments, a substantially uncharged state is one wherein the energy storage device has discharged more than about 65% of its energy storage capacity. In some embodiments, a substantially uncharged state is one wherein the energy storage device has discharged more than about 70% of its energy storage capacity. In some embodiments, a substantially uncharged state is one wherein the energy storage device has discharged more than about 75% of its energy storage capacity. In some embodiments, a substantially uncharged state is one wherein the energy storage device has discharged more than about 80% of its energy storage capacity. In some embodiments, a substantially uncharged state is one wherein the energy storage device has discharged more than about 85% of its energy storage capacity. In some embodiments, a substantially uncharged state is one wherein the energy storage device has discharged more than about 90% of its energy storage capacity. In some embodiments, a substantially uncharged state is one wherein the energy storage device has discharged more than about 95% of its energy storage capacity. In some embodiments, a substantially uncharged state is one wherein the energy storage device has discharged about 100% of its energy storage capacity.

In certain embodiments described herein, “transformation of an energy storage device” comprises transforming said device into component materials. To transform the energy storage devices into component parts, the devices are first sorted based on the electrochemical cell type of each device. For instance, energy storage devices comprising cadmium are collected in a group; devices comprising lead are collected in a group etc. In certain embodiments, the transformation into isolated component materials is initiated by removing combustible material, such as but not restricted to plastics, paper and insulation, with an oxidizer. In certain embodiments, the oxidizer is a gas-fired thermal oxidizer. In certain embodiments, a scrubber is used to eliminate polluting particles created by the oxidation process, before releasing into the atmosphere. After this, the energy storage devices are heated until the metals that constitute said energy storage devices liquefy. In certain embodiments, the devices are chopped into small pieces prior to heating. In some embodiments, non-metallic substances are burned off; leaving a slag, and said slag is removed by a slag arm in certain embodiments. The metal alloys settle according to weight and are skimmed off while in liquid form.

For instance, cadmium is relatively light and vaporizes at high temperatures. For energy storage devices comprising cadmium, a fan blows the cadmium vapor into a cooled receptacle. In certain embodiments, the receptacle is the surface of a tube cooled internally with water mist. The vapors condense on the cool surface to produce cadmium. In some embodiments, the cadmium is of greater than 90% purity. In some embodiments, the cadmium is of greater than 95% purity. In some embodiments, the cadmium is of greater than 99% purity. In some embodiments, the cadmium is of greater than 99.5% purity.

In certain embodiments, the metals are not isolated any further than the alloy stage. In some embodiments, the metal alloys are transported to metal recovery plants where they are used to obtain isolated component metal such as but not limited to nickel, chromium and iron for stainless steel and other high-end products.

### Processing Device

The systems, programs, platforms, and methods described herein include a processing device, or use of the same. In certain embodiments described herein, the processing device is useful to manage distribution and transformation of energy storage devices. In certain embodiments, the processing device includes one or more hardware central processing units (CPU) that carry out the device's functions. In some embodiments, the processing device further comprises an operating system configured to perform executable instructions, a storage device, a display, an input device, a scanning device, and optionally a sound output device. In some embodiments, the digital processing device is optionally connected to the Internet such that it accesses the World Wide Web. In other embodiments, the processing device is optionally connected to an intranet. In other embodiments, the processing device is optionally connected to a data storage device.

In accordance with the description herein, suitable processing devices include, by way of non-limiting examples, server computers, desktop computers, laptop computers, notebook computers, sub-notebook computers, netbook computers, netpad computers, set-top computers, handheld computers, Internet appliances, mobile smart phones, tablet computers, personal digital assistants, and video game consoles. Those of skill in the art will recognize that many smart phones are suitable for use in the system described herein. Those of skill in the art will also recognize that select televisions and select digital music players with computer network connectivity are suitable for use in the system described herein. Suitable tablet computers include those with booklet, slate, and convertible configurations, known to those of skill in the art.

In some embodiments, the processing device described herein includes an operating system configured to perform executable instructions. The operating system is, for example, software, including programs and data, which manages the device's hardware and provides services for execution of applications, performed using the device. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In certain embodiments the processing device includes a storage and/or memory device. The storage and/or memory device is one or more physical apparatuses used to store data or programs on a temporary or permanent basis. In some embodiments, the memory device is volatile memory and requires power to maintain stored information. In some embodiments, the memory device is non-volatile memory and retains stored information when the digital processing device is not powered. In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In certain embodiments the processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, an OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In certain embodiments, the processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

In certain embodiments, a processing device described herein is useful to manage transformation of energy storage devices by use of a charging unit. In certain embodiments, said transformation comprises transformation of energy storage devices to substantially charged energy storage devices. In certain embodiments, the processing device is useful to manage transformation of energy storage devices to a substantially charged state, wherein said transformation is performed by use of at least one charging unit. In certain embodiments, said at least one charging unit is contained within a distribution unit. In certain embodiments, a processing device described herein is useful to manage least one of transformation, storage, inventory, and dispensation of energy storage devices. In certain embodiments, a processing device is useful to monitor individual components of a charging unit such as, but not restricted to a positive component, a negative component and receptacles for containing energy storage devices.

### Computer Network

The systems, programs, platforms, and methods disclosed herein include a processing device that is optionally connected to a computer network, or use of the same. A computer network is a collection of computers and/or devices interconnected by communications channels that facilitate communication and sharing resources among users, computers, or components of the network itself. In view of the disclosure provided herein, the computer network is created by techniques known to those of skill in the art using hardware, firmware, and software known to the art. In some embodiments, the computer network is a private network such as an intranet. In some embodiments, the computer network is the Internet. In further embodiments, the Internet provides access to the World Wide Web and the computer program is provided to the digital processing device via the Web. In still further embodiments, the Internet provides access to the World Wide Web and the computer program is provided to the digital processing device via cloud computing. In other embodiments, the computer network comprises data storage devices including, by way of non-limiting examples, CD-ROMs, DVDs, flash memory devices, magnetic disk drives, magnetic tapes drives, optical disk drives, and cloud computing based storage. In further embodiments, the computer program is provided to the digital processing device via a data storage device.

### Computer Program Instructions

The systems, programs, platforms, and methods described herein include instructions provided by means of a computer program, or use of the same. The computer program includes a sequence of instructions, executable in the processing device's CPU, written to perform a specified task. In light of the disclosure provided herein, those of skill in the art will recognize that the computer program, in various embodiments, utilizes one or more software frameworks and one or more database systems. In some embodiments, the computer program is created upon a software framework such as Microsoft®.NET or Ruby and Rails (RoR). In some embodiments, the computer program utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®.

Those of skill in the art will also recognize that the computer program, in various embodiments, is written in one or more versions of one or more languages. In certain embodiments, the computer program is written in an Object Oriented language. In certain embodiments, the computer program is written in one or more markup languages, presentation definition languages, client-side scripting languages, server-side coding languages, database query languages, or combinations thereof. In some embodiments, the computer program is written to some extent in a markup language such as Hypertext Markup Language (HTML), Extensible Hypertext Markup Language (XHTML), or eXtensible Markup Language (XML). In some embodiments, the computer program is written to some extent in a presentation definition language such as Cascading Style Sheets (CSS). In some embodiments, the computer program is written to some extent in a client-side scripting language such as Asynchronous Javascript and XML (AJAX), Flash® Actionscript, Javascript, or Silverlight®. In some embodiments, the computer program is written to some extent in a server-side coding language such as Active Server Pages (ASP), ColdFusion®, Perl, Java™, JavaServer Pages (JSP), Hypertext Preprocessor (PHP), Python™, Ruby, or Tcl. In some embodiments, the computer program is written to some extent in a database query language such as Structured Query Language (SQL). In some embodiments, the computer program is written to some extent in a programming language such as C, C++ or C#.

In certain embodiments, computer programming instructions are provided in electronic digital memory in a processing device described herein, said instructions useful to manage transformation of energy storage devices. In certain embodiments, computer programming instructions are provided in electronic digital memory in a processing device described herein, said instructions useful to manage transformation of energy storage devices to substantially charged energy storage devices by means of a charging unit. In certain embodiments, the charging unit is contained within a distribution unit. In an embodiment is provided a sequence of computer program instructions as described herein, wherein said sequence of computer program instructions is stored in an electronic digital memory in a processing device, and wherein said sequence of computer program instructions when executed causes at least one of receipt, transformation, inventory, storage, and dispensation of energy storage devices.

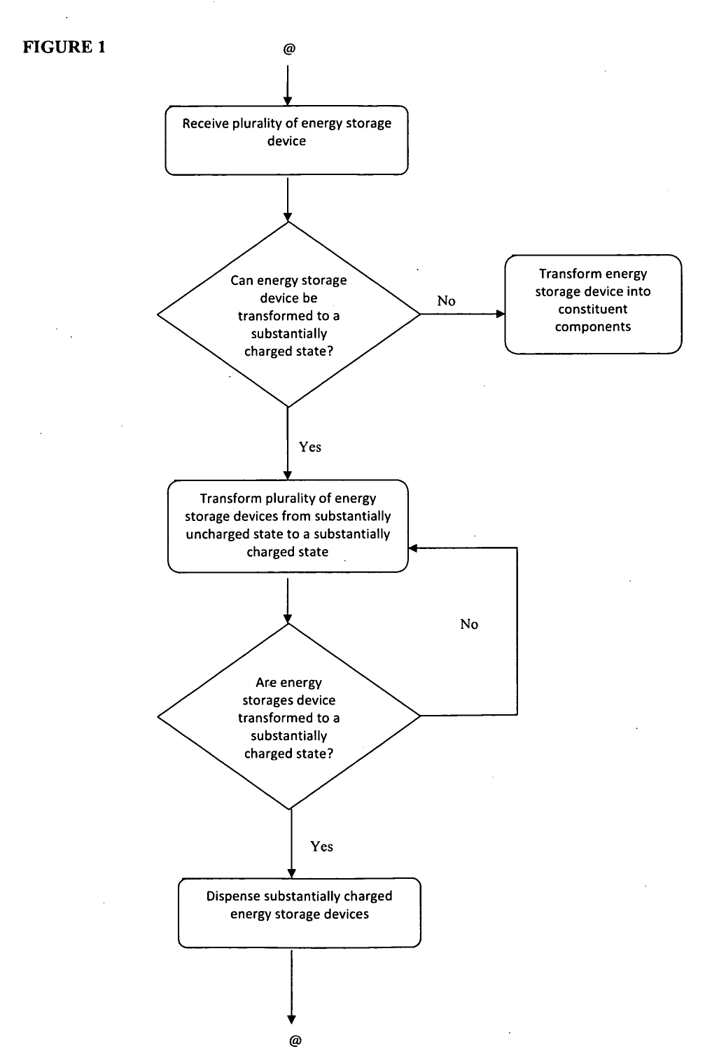

In certain embodiments, are provided computer program instructions for managing steps such as receipt, transformation, and dispensation of energy storage device as described in FIG. 1. In some embodiments are provided computer program instructions for managing receipt of energy storage devices from sender users, verifying if said energy storage devices can be transformed to a substantially charged state, managing transformation of said energy storage devices into substantially charged state or into constituent components (FIG. 1), verifying the transformation of the energy storage devices, and dispensing appropriate charged energy storage devices to recipient users.

### Modules

The systems, programs, platforms, and methods described herein include software, server, and database modules, or use of the same. In view of the disclosure provided herein, these modules are created by techniques known to those of skill in the art using machines, software, and languages known to the art. In some embodiments, the modules are in a single computer program. In other embodiments, the modules are in more than one computer program. In some embodiments, the modules are hosted on one machine. In other embodiments, the modules are hosted on more than one machine. In some embodiments, the modules are hosted on one or more machines in one location. In other embodiments, the modules are hosted on one or more machines in more than one location. Further described herein is the formatting of data. In some embodiments, the data files described herein are formatted in a data serialization format known to those in the art including, by way of non-limiting examples, tab-separated values, comma-separated values, character-separated values, delimiter-separated values, XML, JSON, BSON, and YAML.

### Charging Unit

A “charging unit” is a device used to put energy into an energy storage device such as, but not restricted to a secondary electrochemical cell by forcing an electric current through it. The charge current depends upon the technology and capacity of the device being charged.

In certain embodiments is provided a charging unit that works by supplying a constant DC or pulsed DC power source to an energy storage device that is being charged. In some embodiments the charging unit does not alter its output based on time or the extent of charge present in the energy storage device. In certain embodiments is provided an AC-powered charging unit. In an embodiment, the AC-powered charging unit has a ripple current that is under 5 amps.

In certain embodiments is provided a charging unit that is a trickle charging unit. Trickle charging means charging a rechargeable energy storage device at a similar rate as its self-discharging rate, thus maintaining the device at a substantially charged state. Some rechargeable electrochemical cells such as, but not restricted to nickel-cadmium cells or nickel metal hydride cells, have a moderate rate of self-discharge, meaning they gradually lose their charge even if they are not used in a device. In certain embodiments, the trickle charging unit also comprises a regulator to ensure that the charge rate is not greater than the level of self-discharge in order to prevent overcharging and possible damage or leakage.

In certain embodiments is provided a charging unit that is a float charging unit which is a trickle charging unit with circuitry to prevent overcharging. In certain embodiments, the float charging unit senses when the energy storage device voltage is at the appropriate float level and temporarily ceases charging; it maintains the charge current at zero or a very minimal level until it senses that the output voltage from the energy storage device has fallen, and then resumes charging.

In certain embodiments, the charging unit described herein further comprises a timer, which terminates the charging after a pre-determined time. In certain embodiments is provided a “smart charging unit” for use with a “smart energy storage device.” In certain embodiments, a smart energy storage device is one comprising an electronic device or “chip” that can communicate with a smart charging unit about the energy storage device characteristics and condition. A smart energy storage device generally requires a smart charging unit it can communicate with. A smart charging unit is defined as a charging unit that can respond to the condition of an energy storage device, and modify its charging actions accordingly. Some smart charging are designed to transform smart energy storage devices from a substantially uncharged state to a substantially charged state. Some smart charging units are designed to transform from a substantially uncharged state to a substantially charged state, any energy storage device that lacks internal electronic circuitry. The output current of a smart charging unit depends upon the state of the energy storage device. Charging is terminated when a combination of the voltage, temperature and/or time indicates that the energy storage device is fully transformed to a charged state.

In certain embodiments, the charging unit is a ‘just-in-time’ charging unit. In a further embodiment, a just-in-time charging unit is designed to transform energy storage devices when needed so as to minimize excess charging of the energy storage device. In certain embodiments, a just-in-time charging unit does not transform energy storage devices before it is needed to do so, as determined by a processing device. In some embodiments, the need to transform energy storage devices is determined by the processing device based on the inventory or needs of a recipient user.

In certain embodiments, for Ni—Cd and NiMH electrochemical cells, the voltage across the cell increases slowly during the charging process, until the cell is fully transformed. After that, the voltage decreases, this in some embodiments indicates to a charging unit that the electrochemical cell is fully transformed to a substantially charged state. Such charging units are ΔV, “delta-V,” or sometimes “delta peak”, charging units.

In certain embodiments, the charging unit is a fast charging unit. In some embodiments, the fast charging unit makes use of control circuitry in the energy storage devices being charged to rapidly charge said storage devices without damage. In certain embodiments, the charging units have a cooling fan to help keep the temperature of the cells under control.

In certain embodiments, the charging unit uses pulse technology in which a series of voltage or current pulses is fed to the energy storage device. The DC pulses have a strictly controlled rise time, pulse width, pulse repetition rate (frequency) and amplitude. In certain embodiments, the charging units use pulses to check the current state of the storage device when first connected, and then use constant current charging during fast charging, then use pulse charging as a kind of trickle charging to maintain the charge. Some charging units use “negative pulse charging”, also called “reflex charging” or “burp charging”. Such charging units use both positive and brief negative current pulses. Some charging units are constant current charging units. In certain embodiments of constant-current charging units, the charging unit supplies a relatively uniform current, regardless of the temperature and the extent to which energy storage devices are transformed to a substantially charged state.

In certain embodiments, the charging unit is an inductive charging unit that uses electromagnetic field to transfer energy to at least one energy storage device. The charging unit sends energy through inductive coupling to a receptacle which stores the energy in the energy storage devices. In certain embodiments, the receptacle is a removable receptacle that is detachable from a mailer useful to transport said energy storage devices. In certain embodiments is a charging unit as described herein, wherein the capacity of said unit can be expanded by modularly attaching additional receptacles that can contain a plurality of energy storage devices that are transformed to a substantially charged state when connected to the charging unit by means of the receptacle. In certain embodiments, the modules are detachable receptacles that can be placed in a mailer for transporting energy storage devices.

In certain embodiments, the charging unit is a solar charging unit that converts light energy into electricity. In certain embodiments, solar charging units are used for trickle charging. In certain embodiments, solar charging units are used to completely transform the energy storage device from a substantially uncharged state to a substantially charged state. In certain embodiments, the charging unit comprises turbines that convert kinetic energy into mechanical energy which is used to produce electricity. In certain embodiments, the turbines use kinetic energy from the wind. In some embodiments, the turbines use kinetic energy from sea-waves. In an embodiment, the electricity provided by the charging unit to the energy storage device is obtained from a hydroelectric or wind source.

In some embodiments, the charging unit can simultaneously charge at least 10 energy storage devices. In an embodiment is a charging unit that can simultaneously charge at least 20 energy storage devices. In certain embodiments are charging units that can simultaneously charge at least 50 energy storage devices. In an embodiment provided is a charging unit that can simultaneously charge at least 100 energy storage devices. In some embodiments are charging units that can simultaneously charge at least 1000 energy storage devices. In some embodiments, are charging units that can simultaneously charge at least 10000 energy storage devices. In certain embodiments are charging units that can charge at least 100000 energy storage devices. In certain embodiments, a plurality of charging units are simultaneously provided in a system described herein. In a further embodiment, at least 5 charging units are simultaneously provided in a system described herein. In certain embodiments, 10 charging units are deployed simultaneously to charge a high plurality of energy storage devices. In an embodiment, 50 charging units are provided. In a further embodiment, at least 100 charging units are provided. In some embodiments, at least 1000 charging units that can simultaneously charge between 10 and 100000 energy storage devices are provided in systems described herein. In certain embodiments, at least one charging unit is contained within a distribution unit described herein.

In certain embodiments, the charging unit is useful to transform a high plurality of energy storage units. In certain embodiments, a high plurality of energy storage devices is defined as ‘at least 20 energy storage devices’. In some embodiments, a high plurality of energy storage devices is ‘at least 100 energy storage devices’. In some embodiments, a high plurality of energy storage devices is ‘at least 500 energy storage devices’. In some embodiments, a high plurality of energy storage devices is ‘at least 1000 energy storage devices’. In some embodiments, a high plurality of energy storage devices is at least 10000 energy storage devices.

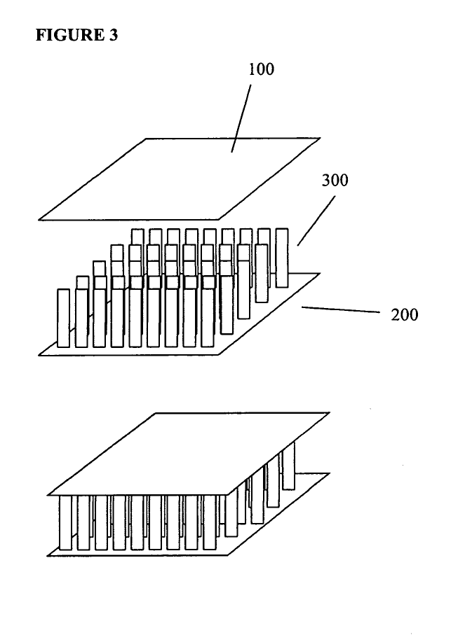

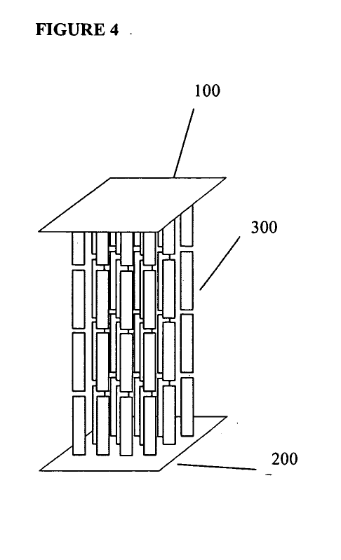

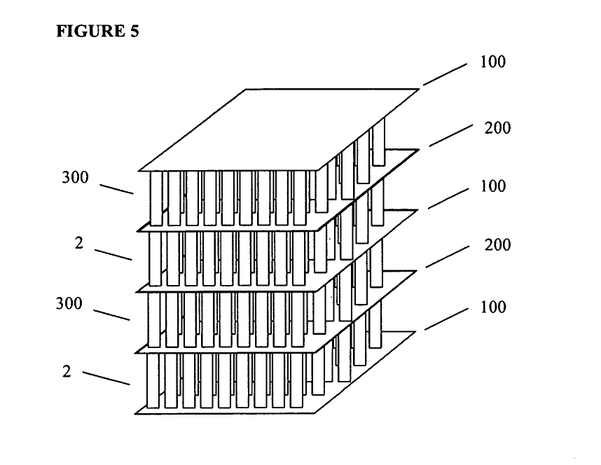

Provided herein is a charging unit (1) for transforming energy storage devices (2) to a substantially charged state, said unit comprising: at least one positive component (100); at least one negative component (200); and receptacles (300) to contain a plurality of energy storage devices (2), wherein said charging unit provides energy in an amount sufficient to transform said energy storage devices to a substantially charged state. In certain embodiments, the receptacles (300) align the plurality of energy storage devices (2) in a series arrangement (such as, but not restricted to the embodiment shown in FIG. 4) between said at least one positive component (100) and said at least one negative component (200). In some embodiments, the receptacles (300) align the plurality of energy storage devices in a parallel arrangement (such as, but not restricted to the embodiments shown in FIG. 3, and FIG. 5) between said at least one positive component (100) and said at least one negative component (200). In a further embodiment, the receptacles (300) comprise a locking mechanism to hold the energy storage devices in place. In some embodiments, the locking mechanism is a clip. In an embodiment, the locking mechanism is a cartridge. In certain embodiments, the locking mechanism is a spring pin. In an embodiment, the locking mechanism is a clamp. In certain embodiments, the locking mechanism is a groove, or a slot. In a further embodiment, the locking mechanism is a gravitational lock. In an embodiment, the locking mechanism is not activated if energy storage devices are placed in the receptacle in an improper orientation.

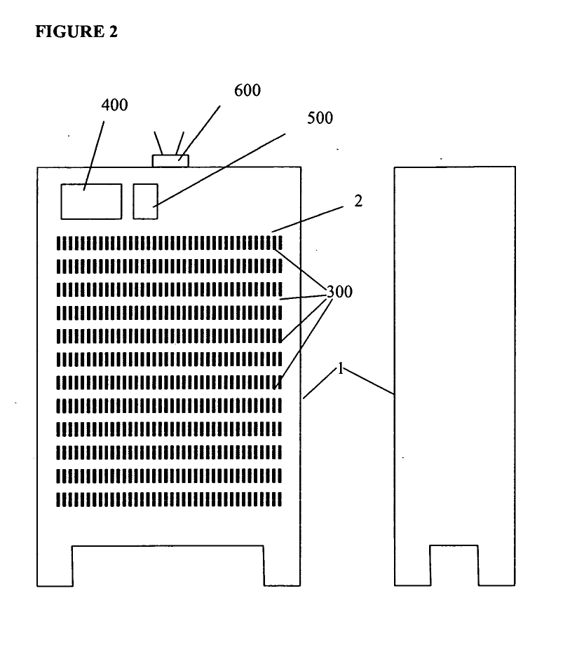

Provided herein is a charging unit (1) (such as but not restricted to the embodiments shown in FIGS. 2-6) for transforming energy storage devices (2) to a substantially charged state, said unit comprising: at least one positive component; at least one negative component; and receptacles to contain a plurality of energy storage devices, wherein said charging unit provides energy in an amount sufficient to transform said energy storage devices to a substantially charged state; and wherein said transformation of the energy storage devices is performed by providing electricity in an amount sufficient to transform said energy storage devices from a substantially uncharged state to a substantially charged state. In certain embodiments, the charging unit maintains substantially charged energy storage devices in said substantially charged state. In an embodiment is a charging unit that can simultaneously charge at least 20 energy storage devices. In certain embodiments are charging units that can simultaneously charge at least 50 energy storage devices. In an embodiment provided is a charging unit that can simultaneously charge at least 100 energy storage devices. In some embodiments are charging units that can simultaneously charge at least 1000 energy storage devices. In some embodiments, are charging units that can simultaneously charge at least 10000 energy storage devices. In certain embodiments are charging units that can charge at least 100000 energy storage devices.

In certain embodiments is provided a charging unit as described herein, wherein the charging unit regulates the supply of energy to the energy storage devices. In some embodiments, the regulation further comprises prevention of overcharging of charged energy storage devices. In an embodiment, at least some of the electricity needed to convert the energy storage devices to a substantially charged state is obtained from a renewable source. In certain embodiments, all of the electricity is obtained from a renewable source. In an embodiment, the renewable source of electricity is solar. In certain embodiments, the renewable source of electricity is biomass, biofuel, geothermal, tidal, hydroelectric, wind, solar or combinations thereof. In a particular embodiment, the charging unit regulates the supply of electricity so as to minimize charging during peak hours. In certain embodiments, the energy storage devices are transformed to a substantially charged state by trickle charging. In some embodiments, the energy storage devices are transformed to a substantially charged state by float charging. In an embodiment, the energy storage devices are transformed to a substantially charged state by delta-V charging. In certain embodiments, the energy storage devices are transformed to a substantially charged state by constant current charging.

In a further embodiment, the energy storage devices are transformed to a substantially charged state by negative pulse charging. In some embodiments, the energy storage devices are transformed to a substantially charged state by inductive charging. In an embodiment, the charging unit is a smart charging unit. In some embodiments, the energy storage device is an electrochemical cell. In some embodiments, the electrochemical cell is rechargeable.

In certain embodiments are provided charging units (such as but not restricted to the embodiment shown in FIG. 2) as described herein wherein said charging units also comprise at least one control panel useful to select charging parameters. In further embodiments the control panel comprises at least one display screen (400). In some embodiments, the display screen is a touchscreen. In some embodiments, the selection panel comprises at least one keyboard (500). In certain embodiments, the charging unit further comprises a network communicator (600). In certain embodiments, the network communicator (600) is useful to communicate with at least one processing device as provided in the systems described herein. In certain embodiments, the network communicator is useful to communicate with other charging units as provided in the systems described herein.

In certain embodiments is provided at least one charging unit (1) as described herein wherein said charging unit can simultaneously transform a plurality of multiple types of energy storage devices (such as but not restricted to the embodiment shown in FIGS. 2-5). In some embodiments, a charging unit described herein further comprises a mechanism to issue an alert. In an embodiment, the alert mechanism is triggered when at least one energy storage device cannot be transformed to a substantially charged state. In certain embodiments, the alert mechanism is triggered when all energy storage devices are transformed to a substantially charged state.

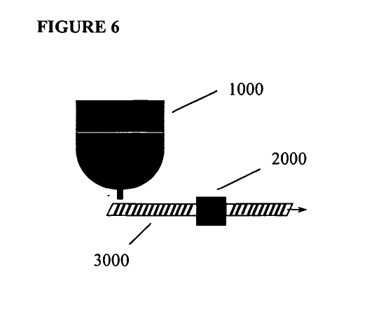

In certain embodiments is provided at least one charging unit (1) (such as but not restricted to the embodiment shown in FIG. 6) as described herein wherein said charging unit further comprises an automated loading device (1000) that accepts energy storage devices (2), and dispenses said devices to an automated sorting device; and an automated sorting device (2000). In certain embodiments, the automated loading device is a hopper. In further embodiments, the charging unit also comprises a conveyor (3000) to transport said energy storage devices from said loading device (1000) to said sorting device (2000). In some embodiments, the sorting device aligns energy storage devices in a proper orientation for containment in the receptacle.

In certain embodiments are charging unit as described herein, wherein said charging units are designed to be contained within a distribution unit.

In certain embodiments described herein, the energy storage device is not an automobile traction battery.

Provided is a method of using a charging unit described herein for efficiently recycling energy storage devices, said method comprising: receiving at least one energy storage device in a substantially uncharged state; transforming said energy storage device from a substantially uncharged state to a substantially charged state; initiating transportation to said substantially charged energy storage device to a user. In certain embodiments, the energy storage device is an electrochemical cell. In some embodiments, the electrochemical cell is rechargeable.

1. A system for transformation of energy storage devices, wherein said system comprises:
at least one charging unit for transformation of a high plurality of energy storage devices to a substantially charged state by providing a sufficient amount of electricity;
at least one processing unit optionally comprising a computer;
at least one sequence of program instructions stored in an electronic digital memory in said processing unit, which when executed cause at least one step selected from transformation, inventory, and storage of energy storage devices; and
optionally comprising a distribution unit to: receive energy storage devices from a sender user, dispense substantially charged energy storage devices to a recipient user, or both.

2. (canceled)

3. (canceled)

4. A system as described in claim 1 wherein the charging unit maintains substantially charged energy storage devices in said substantially charged state.

5. A system as described in claim 1, wherein the charging unit can simultaneously charge from at least about 20 energy storage devices to at least about 100000 energy storage devices.

6. (canceled)

7. (canceled)

8. (canceled)

9. (canceled)

10. (canceled)

11. A system as described in claim 1, wherein said system comprises from about 2 to about 10000 charging units.

12. (canceled)

13. (canceled)

14. (canceled)

15. (canceled)

16. (canceled)

17. (canceled)

18. A system as described in claim 1, wherein said system regulates the supply of electricity to the energy storage devices by at least one: preventing overcharging of charged energy storage devices, and minimizing charging during peak hours.

19. (canceled)

20. A system as described in claim 1 wherein at least some of said electricity is obtained from a renewable source selected from solar, biomass, biofuel, geothermal, tidal, hydroelectric, wind and combinations thereof.

21. (canceled)

22. (canceled)

23. (canceled)

24. (canceled)

25. A system as described in claim 1 wherein each energy storage device is an electrochemical cell selected from a rechargeable cell and a non-rechargeable cell, wherein said rechargeable cell is not an automobile traction battery.

26. (canceled)

27. (canceled)

28. A system as described in claim 1, wherein at least one charging unit is one of: an electrochemical cell testing equipment, and a formation and grading machine.

29. (canceled)

30. (canceled)

31. (canceled)

32. A system as described in claim 1, wherein said charging unit is placed within said distribution unit or wherein said charging unit is separate from said distribution unit and the energy storage devices are transported between said separate distribution unit and said charging unit by means of a delivery service.

33. (canceled)

34. (canceled)

35. (canceled)

36. (canceled)

37. (canceled)

38. (canceled)

39. A system as described in claim 1, said charging unit comprising:
at least one positive component;
at least one negative component; and
receptacles to contain a plurality of energy storage devices, wherein said receptacles optionally align the plurality of energy storage devices in at least one of: a series arrangement and a parallel arrangement between said at least one positive component and said at least one negative component.

40. (canceled)

41. (canceled)

42. A system as described in claim 39, wherein said receptacles comprise a locking mechanism to hold the energy storage devices in place wherein said locking mechanism optionally comprises one of: a clip and a cartridge; and wherein said locking mechanism is optionally deactivated if energy storage devices are placed in the receptacle in an improper orientation.

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. A system as described in claim 1 wherein the transformation of energy storage devices to a substantially charged state is by at least one of: trickle charging, float charging, delta-V charging, negative pulse charging, inductive charging and constant current charging.

63. (canceled)

64. (canceled)

65. (canceled)

66. (canceled)

67. (canceled)

68. A system as described in claim 1, wherein said charging unit is a smart charging unit.

69. (canceled)

70. (canceled)

71. A system as described in claim 1, said charging unit comprising a control panel useful to select charging parameters, said charging panel optionally comprising at least one display screen which is optionally a touchscreen and at least one keyboard.

72. (canceled)

73. (canceled)

74. (canceled)

75. (canceled)

76. A system as described in claim 1, said charging unit comprising a mechanism to issue an alert.

77. (canceled)

78. A system as described in claim 76 wherein said alert is triggered when at least one energy storage device cannot be transformed to a substantially charged state or when all energy storage devices are transformed to a substantially charged state.

79. A system as described in claim 1, said charging unit comprising:
an automated loading device that accepts energy storage devices, and dispenses said devices to an automated sorting device wherein said loading device optionally comprises a hopper;
an automated sorting device, wherein said sorting device optionally aligns energy storage devices in a proper orientation for containment in the receptacle; and
optionally a conveyor to transport said energy storage devices from said loading device to said sorting device.

80. (canceled)

81. (canceled)

82. (canceled)

83. (canceled)

84. (canceled)

85. A method of using a charging unit for efficiently recycling energy storage devices comprising:
receiving at least one energy storage device in a substantially uncharged state;
transforming said energy storage device from a substantially uncharged state to a substantially charged state;
initiating transportation to said substantially charged energy storage device to a user.

86. The method of claim 85, wherein said energy storage device is an electrochemical cell.

87. (canceled)

88. (canceled)
